(19) United States
(12) Patent Application Publication
(10) Pub. No.: US 2002/0022467 A1
(43) Pub. Date: Feb. 21, 2002

(54) Wireless communication apparatus for communicating between terminals in a wireless network

(76) Inventor: Kazushige Matsui, Ohtsu-shi (JP)

Correspondence Address: Bruce Schelkopf, IBM Corp., Personal Systems Group Legal Dept., Dept. 9CCA/Bldg. 002-2, Research Triangle Park, NC, 27709, US

(21) Appl. No.: 09/770,103

(22) Filed: Jan. 25, 2001

(30) Foreign Application Priority Data
Jan. 25, 2000 (JP) 2000-16017

(51) Int. Cl. H04M 9/00

(52) U.S. Cl. 455/402; 455/572

(57) ABSTRACT

A wireless communication apparatus is adapted to conduct stable wireless communication with one or more wireless communication sub-units and comprises a power supply connecting section connected to a power socket for lighting, communicating means connected to the power supply connecting section and conducting communication between one or more wireless communication sub-units and the other wireless communication main-units, and a lamp connecting section, electrically connected to the power supply connecting section and to which a power supply plug of an electric lamp is connected.

### FIELD OF THE INVENTION

The present invention relates to a wireless communication network system and communication method using a wireless communication apparatus. More particularly, it relates to a wireless communication main unit for conducting wireless communication with one or more wireless communication sub-units connected to a terminal unit, and a network system and communication method using this wireless communication main unit.

### BACKGROUND OF THE INVENTION

As a method of setting up a network for computers, or the like at an ordinary house or an office, and the like, two methods of setting up a network such as a network setup by wired connection and a network setup by wireless communication are used.

When a terminal unit placed in a large room such as an office is wired to set up a network by a wired connection, it is relatively easy to set up the network due to wiring inside the room. When terminal units placed in a plurality of rooms, such as in an ordinary house, are wired, however, an operation such as boring a hole in the wall for wiring is required for the network construction. Moreover, each time a terminal unit is added, wiring has to be carried out for the terminal unit.

Because of no need for wiring between terminal units, the network construction by wireless communication can be easily performed. It is, however, common to use an extremely low-power radio waves for wireless communication instead of high-power radio waves due to restrictions imposed by legislation. The communication area is narrow because the radio waves used for wireless communication are not very strong, so that the distance between the terminal units in a large room such as an office, or in a room and the other room may exceed the communication area. Further, there are many difficult cases in realizing stable wireless communication, such as a shutdown of communication caused by someone passing between the terminal units which are in the process of wireless communication.

### SUMMARY OF THE INVENTION

It is an object of the present invention to provide a wireless communication main unit which is easily installed and is capable of conducting stable wireless communication with one or more wireless communication sub-units, and a network system and a communication method which are easily set up and enable stable wireless communication.

The wireless communication main unit according to the present invention comprises a power supply connecting section connected to a power socket for lighting, communicating means, connected to the power supply connecting section and conducting communication between one or more wireless communication sub-units and the other one or more wireless communication main units, and a lamp connecting section, electrically connected to the power supply connecting section and to which a power supply plug for lighting is connected.

The network system of the present invention includes a plurality of wireless communication main units, respectively comprising a power supply connecting section connected to the power socket for lighting, and communicating means, connected to the power supply connecting section and conducting communication between the wireless communication sub-units and the other wireless communication main units.

The communication method of the present invention comprises the steps of: receiving information transmitted from a first wireless communication sub-unit connected to a first terminal unit using a first wireless communication main unit, transmitting the information received by the first wireless communication main unit to a second wireless communication main unit connected to another power socket for lighting through a power line, and transmitting the information received by the second wireless communication main unit to a second wireless communication sub-unit connected to a second terminal unit via wireless communication.

Since the wireless communication main unit of the present invention can be mounted on a power socket for lighting, stable wireless communication with one or more sub-units can be attained, as well as easy installation. Further, it is unnecessary to secure extra power supply due to electric power obtained from the power socket.

### BRIEF DESCRIPTION OF THE DRAWINGS

FIG. 1 is a block diagram for showing a structure example of a wireless communication unit (main unit) according to the present invention.

FIG. 2 shows a connection example among the main unit, a power socket for lighting, and an electric lamp shown in FIG. 1 according to the present invention.

FIG. 3 shows one example of a communication network using the main unit shown in FIG. 1.

FIG. 4 shows the other example of the communication network using the main unit shown in FIG. 1.

FIGS. 5(a) through (c) show another examples of the structure of the wireless communication units (main unit) according to the present invention.

FIG. 6 is a block diagram of the other example of the structure of the wireless communication unit (main unit) according to the present invention.

FIG. 7 shows an example of the structure of an electric lamp and a connection between a power socket for lighting and a power supply plug.

FIGS. 8(a) and (b) illustrate the power socket for lighting (110) shown in FIG. 7. FIG. 8(a) is a side view and FIG. 8(b) is a bottom plan view.

FIGS. 9(a) and (b) illustrate the power supply plug (120) shown in FIG. 7. FIG. 9(a) is a side view, and FIG. 9(b) is a top plan view.

FIGS. 10(a) and (b) are X-X line cutting sectional views respectively showing the power socket for lighting shown in FIG. 7.

### DESCRIPTION OF THE PREFERRED EMBODIMENTS

Now, a preferred embodiment of the wireless communication main unit, the network system, and the communication method using this wireless communication main unit according to the present invention will be described in detail with reference to the accompanying drawings.

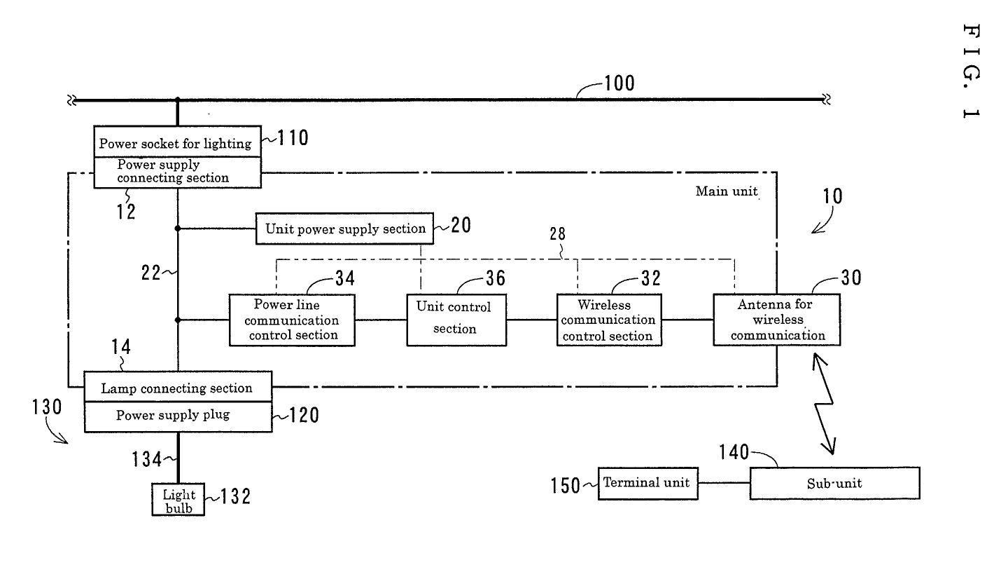

FIG. 1 shows an example of the structure of a wireless communication main unit 10 according to the present invention. The wireless communication main unit is used by combination with a wireless communication sub-unit 140 connected to a terminal unit 150. Particularly, wireless communication is carried out between the wireless communication main unit 10 and the wireless communication sub-unit 140.

The wireless communication main unit 10 is connected to the other one or more wireless communication main units 10 respectively to set up a network system. The wireless communication main unit 10 is hereinafter referred to as main unit. Similarly, the wireless communication sub-unit 140 is referred to as sub-unit.

The main unit 10 comprises a power supply connecting section 12 connected to a power socket 110 for lighting, communicating means (30, 32, 34, and 36) connected to the power supply connecting section 12, and a lamp connecting section 14 connected to a power supply plug 120 for an electric lamp 130. There is continuity between the power supply connecting section 12 and the lamp connecting section 14 through wiring 22. The power supply connecting section 12 includes a plug identical to the power supply plug 120 for the electric lamp 130. The lamp connecting section includes a socket identical to the power socket 110 for lighting.

FIG. 7 shows an example of the power socket 110 for lighting and the electric lamp 130. In general, the power socket 110 is provided on a ceiling 138 of the room. The power socket 110 is connected to a power line 100. The electric lamp 130 includes a light bulb 132, a shade 136 put on the light bulb 132, a light bulb cable 134 for providing electric power for the light bulb 132, and the power supply plug 120 equipped with the end portion of the light bulb cable 134. The power supply plug 120 is connected and fixed to the power socket 110 to hang the electric lamp 130 from the ceiling 138, as well as providing electric power for the light bulb 132.

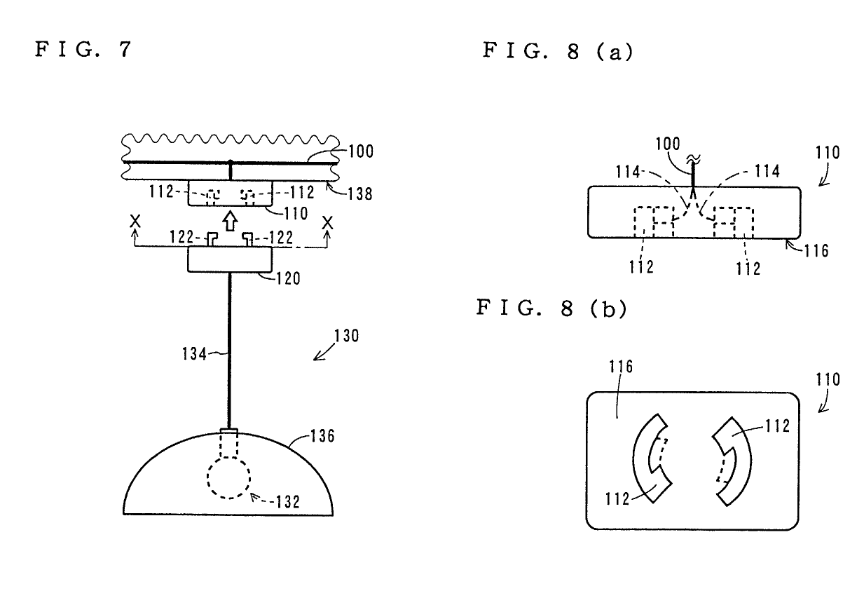

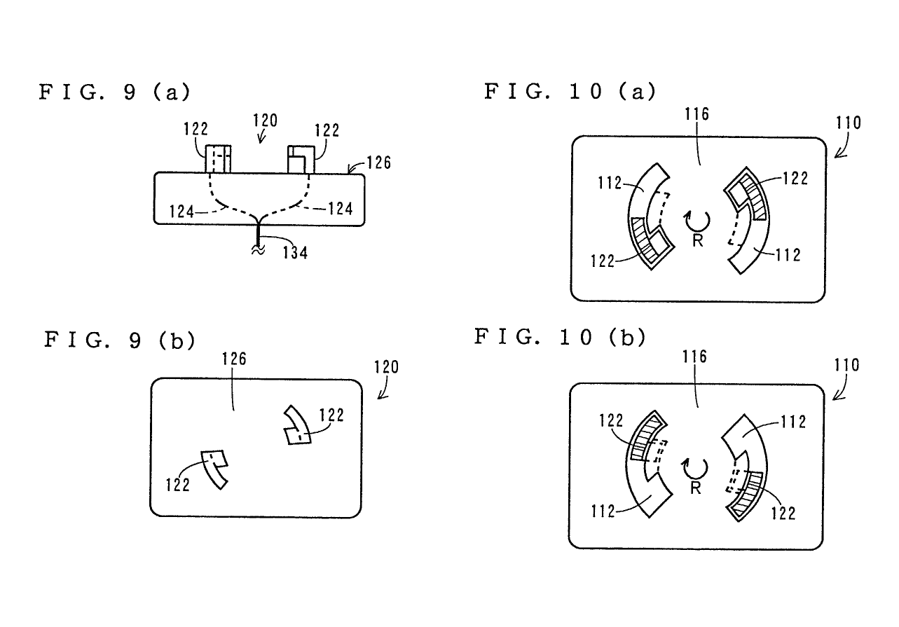

The power supply plug 120 and the power socket 110 for lighting can be connected and fixed, for example, by inserting plug terminals 122 for the power supply plug 120 into plug inserting portions 112 of the power socket 110 to be twisted. In this case, enlarged views of the power socket 110 are shown in FIGS. 8(a) and 8(b), and enlarged views of the power supply plug 120 are shown in FIGS. 9(a) and 9(b). As shown in FIGS. 8(a) and 8(b), the power socket 110 includes two plug inserting portions 112 on the same surface (connecting surface 116). The power line 100 is connected to the opposite side of the connecting surface 116. The wiring 114 connects between the power line 100 and the plug inserting portions 112. As shown in FIGS. 9(a) and 9(b), the power supply plug 120 includes two plug terminals 122 on the same surface (connecting surface 126). A light bulb cable 134 is connected to the opposite side of the connecting surface 126. Wiring 124 connects between the plug terminals 122 and the light bulb cable 134. As shown in FIG. 10(a), the plug terminals 122 for the power supply plug 120 are inserted into the plug inserting portions 112 of the power socket 110. As shown in FIG. 10(b), the power supply plug 120 is inserted and twisted in the direction of arrow R indicated in the drawing to connect the power supply plug 120 to the power socket 110 to be fixed.

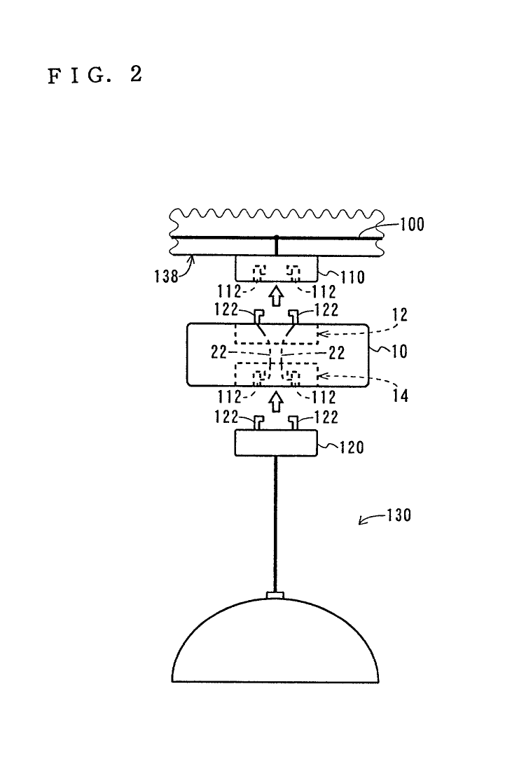

Since the power supply connecting section 12 according to the present invention includes a plug identical to the power supply plug 120 of the electric lamp 130, as shown in FIG. 2, the power supply connecting section 12 of the main unit 10 can be connected to the power socket 110 for lighting to be fixed. Moreover, the lamp connecting section 14 of the main unit 10 according to the present invention includes a socket identical to the power socket 110, so that the power supply plug 120 of the electric lamp 130 can be connected to the lamp connecting section 14 of the main unit 10 to be fixed.

Inclusion of a plug identical to the power supply plug 120 in the power supply connecting section 12 means herein that the power supply connecting section 12 includes at least plug terminals identical to the plug terminals 122. Similarly, the inclusion of a socket identical to the power socket 110 for lighting in the lamp connecting section 14 means that the lamp connecting section 14 includes at least plug inserting portions 112 identical to the power socket 110.

The communicating means (30, 32, 34, and 36) of the main unit 10 comprises: a power line communication control section 34, connected to the power supply connecting section 12 through wiring 22 and conducting communication via the power line 100 with the other main units connected to the other power sockets for lighting, an antenna 30 for wireless communication, a wireless communication control section 32 connected to the antenna 30 and conducting wireless communication with the sub-units 140 using the antenna 30, and a unit control section 36, connected between the power line communication control section 34 and the wireless communication control section 32 for controlling the power line communication control section 34 and the wireless communication control section 32 in addition to data transmission between the power line communication control section 34 and the wireless communication control section 32.

Further, each of the main unit 10 includes a unit power supply section 20 connected to the power supply connecting section 12 through wiring 22. And the power supply connecting section 12 transforms the output voltage of the power socket 110 for lighting to a particular voltage, which is given to the communicating means (30, 32, 34, and 36) through wiring 28. Two lines of wiring 22 connects, as shown in FIG. 2, the power supply connecting section 12 to the lamp connection section 14. The two lines of wiring 22 connects the unit power supply section 20 to the power line communication control section 34 as well.

Now, the operation of the network system and the communication method using such main units 10 will be described.

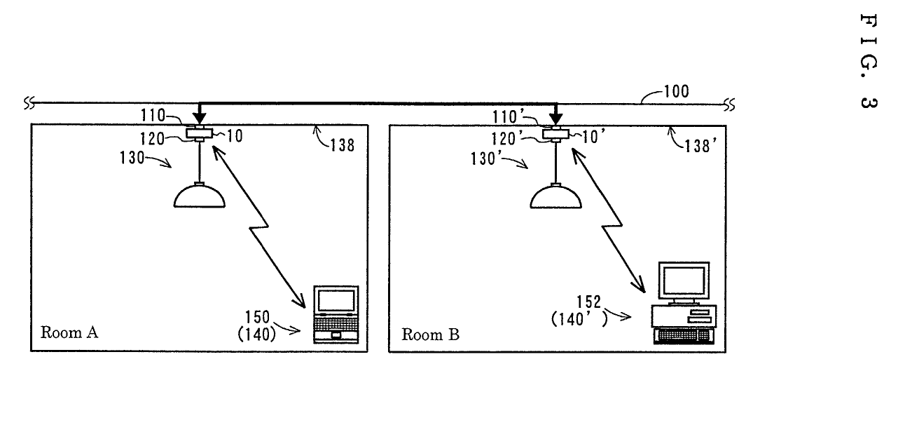

FIG. 3 shows an example of alignment among the main units 10 and the sub-units 140, and the status of connection between the main units 10. In FIG. 3, a terminal unit 150 is placed in Room A and a terminal unit 152 is placed in Room B. The sub-unit 140 is connected to or built into the terminal unit 150, and the sub-unit 140′ is connected to or built into the terminal unit 152, although they are not shown in the figure. Each of the main units 10 is mounted between a power socket 110 for lighting and a power supply plug 120 in the Room A. A main unit 10′ is mounted between a power socket 110′ for lighting and a power supply plug 120′ in the Room B.

When data is sent from the terminal unit 150 placed in the Room A to the terminal unit 152 placed in the Room B, first of all, data is sent from the terminal unit 150 to the sub-unit 140 (not shown). The sub-unit 140 which has received data transmits the data by wireless to the main unit 10. The main unit 10 placed in the Room A receives the data sent by wireless from the sub-unit 140 through the antenna 30. The received data is sent from the wireless communication control section 32 of the main unit 10 to the power line communication control section 34, and then is sent from the power line communication control section 34 to the main unit 10′ in the Room B via the power line 100.

The main unit 10′ placed in the Room B receives the data sent via the power line 100 in the power line communication control section 34. The received data is sent from the power line communication control section 34 of the main unit 10 to the wireless communication control section 32 to be sent by wireless from the antenna 30 to the sub-unit 140′ (not shown). The sub-unit 140′ placed in the Room B receives the data sent by wireless from the main unit 10′ to send the received data to the terminal unit 152.

Thus, data can be transmitted from the terminal unit 150 in the Room A to the terminal unit 152 in the Room B. Data transmission from the terminal unit 152 in the Room B to the terminal unit 150 in the Room A can be performed in a similar manner.

The whole room is nearly within the wireless communication area between the sub-unit 140 and the main unit 10 because the power socket 110 for lighting is located in the center of the room in many cases. In addition, there are few cases that the wireless communication between the sub-unit 140 and the main unit 10 is shut down due to the power socket 110 provided on the ceiling 138. Accordingly, stable wireless communication can be conducted. Since at least one power socket 110 for lighting is mounted per room, it is easy to mount the main units 10 in all rooms. In the case of a large room which is beyond the wireless communication area, often having a plurality of electric lamps, the part which exceeds the wireless communication area may be eliminated by installing respective main units 10 in the portions where a plurality of electric lamps are provided.

The power supply connecting section of the main unit 10 including a plug identical to the power supply plug 120 of the electric lamp 130 allows the main unit 10 to be connected or fixed to the power socket 110 for lighting like the electric lamp 130. The main unit 10 can be, therefore, easily installed. Moreover, there is no need to prepare an extra place to store the main unit 10 because of being installed in the vicinity of the ceiling. The electric lamp 130 can remain to be used in a similar manner as was before by inserting the electric lamp 130 into the lamp connection section 14 electrically connected to the power supply connecting section 12. No extra power supply for the main unit 10 is required to be assured because electric power can be obtained from the power line 100 by the connection of the main unit 10 to the power socket 110.

The power line 100 is used for connecting each of the main units 10, so that no connecting cable is required to be newly prepared or wired. For this reason, it is easy to connect between the main units and to construct a network system. Further, the main units are connected each other with the power line, so that stable communication can be conducted between the main units as well.

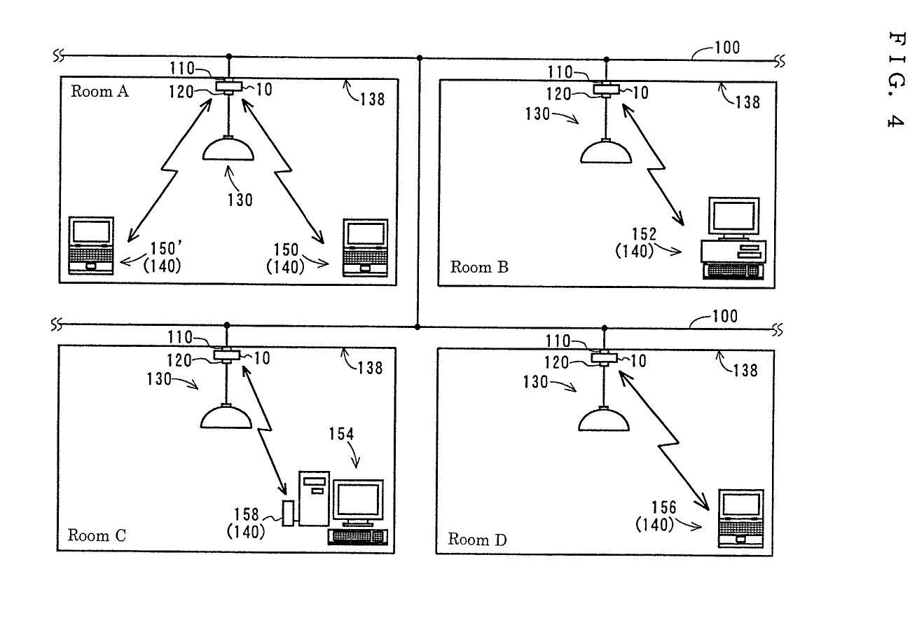

One embodiment according to the present invention has been described in detail so far, but the present invention is, however, not so limited to the above-mentioned embodiment. For example, the connection between the two terminal units 150 and 152 has been described as an example in FIG. 3. As shown in FIG. 4, more than three terminal units 150, 152, and 154, and 156 may be connected. A network controller 158 for supervising and controlling signals which appear on the power line 100 is connected to the terminal unit 154 in Room C. In addition, as shown in the Room A in FIG. 4, wireless communication between the terminal units 150 and 150′ via the main unit 10 can be, of course, possible.

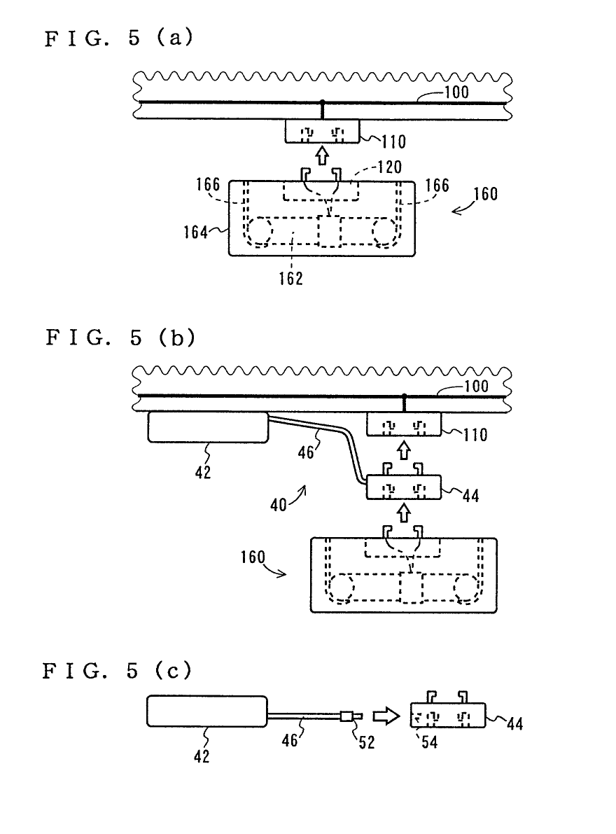

As shown in FIG. 5(a), when a shade 164 is inserted into the power supply plug 120 of an electric lamp 160, and a fluorescent light 162 is supported by supports 166, there is a possibility that the shade 164 may interrupt wireless communication between the main unit 10 and the sub-unit 140. Accordingly, as shown in FIG. 5(b), a main unit 40 may comprise a connecting portion 44 including a power supply connecting section 12 and a lamp connecting section 14, a main body 42 including a unit power supply section 20 and communicating means (30, 32, 34, 36), and a connecting line 46 for connecting both main body 42 and connecting portion 44.

As shown in FIG. 5(c), the above-mentioned connecting portion 44 of the main unit 40 can freely be connected to or disconnected to the connecting line 46 using connecting terminals 52 and 54 as well. Thus, free connection or disconnection of the connecting portion 44 makes it possible to select the connecting portion 44 to be used according to the shape of the power socket 110 for lighting, for example, by preparing plural kinds of the connecting portions 44.

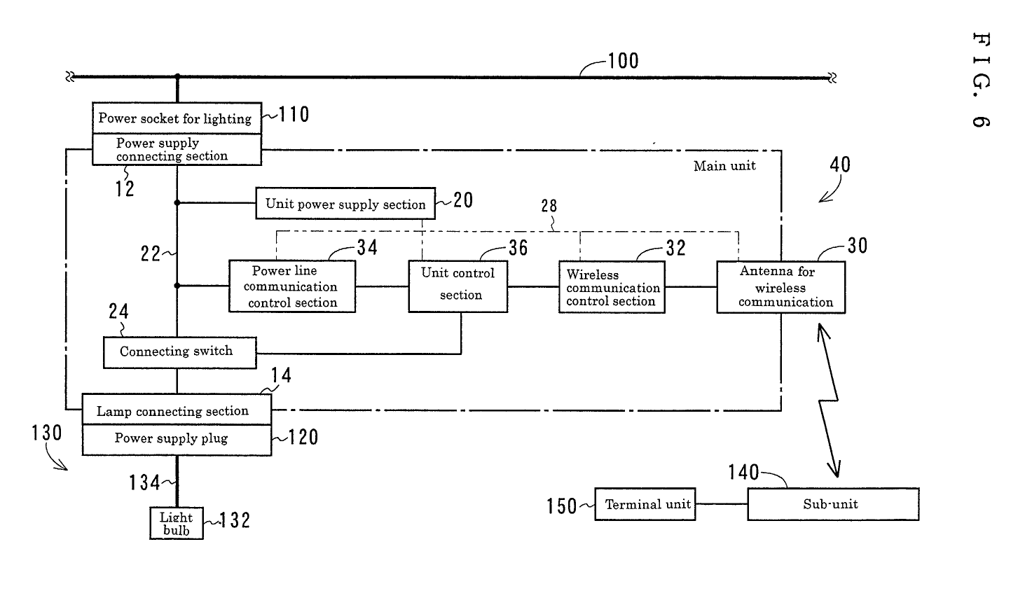

As shown in FIG. 6, a connecting switch 24 is placed between the power supply connecting section 12 and the lamp connecting section 14 so that the connecting switch 24 can also be switched ON or OFF using the unit control section 36 based on predetermined signals received by the communicating means (30 and 34). The arrangement of this kind of connecting switch 24 sends the predetermined signals from the terminal unit to the main unit 40. Consequently, the unit control section 36 can switch the connecting switch 24 to be disconnected from being in the connected state. This results in a shut down of power supply to the electric lamp 130, if only the terminal unit is operated.

The connecting switch can be switched ON or OFF based on a timer by adding a timer function to the unit control section 36 of the main unit 40 shown in FIG. 6. An addition of the timer function can designate time using the terminal unit 150, for example, and switch ON or OFF of the electric lamp 130 at designated time as well.

The main unit can provide communication with an electric appliance, and the like having an infrared ray communication facility by adding the infrared ray communication facility to the main unit. With the infrared ray communication facility, for example, it is also possible to operate the electric appliance having the infrared ray communication facility which is located in the other room. A rechargeable battery or a dry battery is attached to the unit power supply section 20 to operate the main unit even at the time of power failure.

Particular embodiments of the present invention have been variously described so far, but the invention is not limited to the embodiments. For example, a main unit may be installed to a power socket for air conditioner. The power supply connecting section and the lamp connection section of the main unit should be in the same shape as the power socket and the power supply plug for air conditioner. Also, any modification, variations or equivalent arrangements which may occur to those skilled in the art should be considered to be within the scope of the present invention.

There have thus been shown and described a wireless communication main unit, and a network system and a communication method using the main unit which fulfill all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

1. Wireless communication apparatus for facilitating communication between terminals in a wireless network, comprising:
a power supply connecting section adapted for connection to a lighting power socket;
communicating means, connected to the power supply connecting section, for conducting wireless communication with the terminals and for communicating via the lighting power socket with one or more wireless communication apparatus connected thereto; and
a lamp connecting section, electrically connected to the power supply connecting section adapted to receive a power supply plug for lighting.

2. The apparatus according to claim 1, wherein said power supply connecting section includes a plug equivalent to the power supply plug for lighting.

3. The apparatus according to claim 1, wherein said lamp connecting section includes a socket equivalent to the socket for lighting.

4. The apparatus according to claim 1, said communicating means comprising:
a power line communication control section, connected to the power supply connecting section and conducting communication via a power line with the other wireless apparata connected to the other power sockets for lighting;
an antenna for wireless communication;
a wireless communication control section, connected to the antenna for wireless communication and conducting wireless communication with the wireless terminals; and a communication control section, connected between the power line communication control section and the wireless communication control section, and transferring data between the power line communication control section and the wireless communication control section.

5. The apparatus according to claim 1, further comprising a unit power supply section connected to said power supply connecting section and converting output voltage of the power socket for lighting to a predetermined voltage to be supplied to said communicating means.

6. The apparatus according to claim 1, further comprising:
a connecting switch placed between the power supply connecting section and the lamp connecting section; and
a connecting switch control section for switching the connecting switch ON or OFF based on predetermined signals received by the communicating means.

7. A network system comprising:
a plurality of wireless terminals; and
a plurality of wireless communication apparata for conducting wireless communication with the wireless terminals,
wherein each of said wireless communication apparata includes:
a power supply connecting section connected to a power socket for lighting; and
communicating means, connected to the power supply connecting section for conducting communication between the wireless terminals and one or more of the plurality of wireless communication apparata.

8. The system according to claim 7, wherein each of said wireless communication apparata further includes a lamp connecting section, electrically connected to the power supply connecting section and to which a power supply plug for lighting is connected.

9. The system according to claim 7, wherein said power supply connecting section of the wireless communication apparatus includes a plug equivalent to the power supply plug for lighting.

10. The system according to claim 9, wherein said lamp connecting section of the wireless communication apparatus includes a socket equivalent to the socket for lighting.

11. The system according to claim 7, wherein said communicating means of the wireless communication apparatus comprises:
a power line communication control section, connected to the power supply connecting section and conducting communication via a power line with the other wireless communication apparata connected to the other power sockets for lighting;
an antenna for wireless communication;
a wireless communication control section, connected to the antenna for wireless communication and conducting wireless communication with the wireless terminals using the antenna; and
a communication control section, connected between the power line communication control section and the wireless communication control section, and transferring data between the power line communication control section and the wireless communication control section.

12. The system according to claim 7, wherein each of said wireless communication apparata includes the unit power supply section connected to the power supply connecting section and converting the output voltage of the power socket for lighting to a predetermined voltage to be supplied to the communicating means.

13. The system according to claim 8, each of said wireless communication main units further comprising:
a connecting switch placed between the power supply connecting section and the lamp connecting section; and
a connecting switch control section for switching the connecting switch ON or OFF based on predetermined signals received by the communicating means.

14. A method of communicating between wireless terminals in a wireless network comprising the steps of:
receiving information transmitted from a first wireless terminal, using a first wireless communication apparatus connected to a first lighting power socket;
transmitting, through a power line, the information received by the first wireless communication to a second wireless communication apparatus connected to a second lighting power socket; and wireless transmitting the information received by the second wireless communication apparatus to a second wireless terminal.

15. A wireless communication apparatus for facilitating communication in a wireless network comprising:
a power supply connecting section adapted for connection to a lighting circuit;
communicating means, connected to the power supply connecting section, for conducting wireless communication with at least one wireless terminal and for communicating with another similar wireless communication apparatus by means of the lighting circuit.
